(19) United States
(12) Patent Application Publication
(10) Pub. No.: US 2013/0084521 A1
(43) Pub. Date: Apr. 4, 2013

(54) CARRIER CORE PARTICLES FOR ELECTROPHOTOGRAPHIC DEVELOPER, CARRIER FOR ELECTROPHOTOGRAPHIC DEVELOPER, ELECTROPHOTOGRAPHIC DEVELOPER AND METHOD FOR MANUFACTURING THE CARRIER CORE PARTICLES

(71) Applicant: Takeshi Kawauchi, Okayama-City (JP)

(72) Inventor: Takeshi Kawauchi, Okayama-City (JP)

(73) Assignees: DOWA IP CREATION CO., LTD., Okayama-City, Okayama (JP); DOWA ELECTRONICS MSTERIALS CO., LTD, Tokyo (JP)

(21) Appl. No.: 13/704,016

(22) PCT Filed: May 17, 2011
(86) PCT No.: PCT/JP2011/061332

§ 371 Date: Dec. 13, 2012

(30) Foreign Application Priority Data
Jun. 14, 2010 (JP) 2010-135168

(51) Int. Cl. G03G 9/113; G03G 9/10

(52) U.S. Cl. CPC G03G 9/1132; G03G 9/10
USPC 430/110.2; 430/111.1; 430/137.18

(57) ABSTRACT

The carrier core particles for electrophotographic developer include a core composition expressed by a general formula Fe₃O₄ as a main ingredient and 30 ppm to 400 ppm Na. Such carrier core particles can reduce environmental dependency thereof, while optimizing the resistivity.

### TECHNICAL FIELD

This invention relates to carrier core particles for electrophotographic developer (hereinafter, sometimes simply referred to as “carrier core particles”), carrier for electrophotographic developer (hereinafter, sometimes simply referred to as “carrier”), electrophotographic developer (hereinafter, sometimes simply referred to as “developer”), and a method for manufacturing the carrier core particles for the electrophotographic developer. More particularly, this invention relates to carrier core particles contained in electrophotographic developer used in copying machines, MFPs (Multifunctional Printers) or other types of electrophotographic apparatuses, carrier contained in electrophotographic developer, electrophotographic developer and a method for manufacturing the carrier core particles for the electrophotographic developer.

### BACKGROUND ART

Electrophotographic dry developing systems employed in a copying machine, MFP or other types of electrophotographic apparatuses are categorized into a system using a one-component developer containing only toner and a system using a two-component developer containing toner and carrier. In either of these developing systems, toner charged to a predetermined level is applied to a photoreceptor. An electrostatic latent image formed on the photoreceptor is rendered visual with the toner and is transferred to a sheet of paper. The image visualized by the toner is fixed on the paper to obtain a desired image.

A brief description about development with the two-component developer will be given. A predetermined amount of toner and a predetermined amount of carrier are accommodated in a developing apparatus. The developing apparatus is provided with a rotatable magnet roller with a plurality of south and north poles alternately arranged thereon in the circumferential direction and an agitation roller for agitating and mixing the toner and carrier in the developing apparatus. The carrier made of a magnetic powder is carried by the magnet roller. The magnetic force of the magnet roller forms a straight-chain-like magnetic brush of carrier particles. Agitation produces triboelectric charges that bond a plurality of toner particles to the surface of the carrier particles. The magnetic brush abuts against the photoreceptor with rotation of the magnet roller and supplies the toner to the surface of the photoreceptor. Development with the two-component developer is carried out as described above.

Fixation of the toner on a sheet of paper results in successive consumption of toner in the developing apparatus, and new toner in the same amount as that of the consumed toner is supplied, whenever needed, from a toner hopper attached to the developing apparatus. On the other hand, the carrier is not consumed for development and used as it is until the carrier comes to the end of its life. The carrier, which is a component of the two-component developer, is required to have various functions including: a function of triboelectrically charging the toner by agitation in an effective manner; an insulating property; and a toner transferring ability to appropriately transfer the toner to the photoreceptor.

The recently dominating carrier includes carrier core particles, which are the core or the heart of the carrier particles, and coating resin that covers the surfaces of the carrier core particles.

The carrier core particles are required to have good magnetic properties. Briefly speaking, the carrier in the developing apparatus is carried by a magnet roller with magnetic force. In such usage, if the magnetism, more specifically, the magnetization of the carrier core particles is low, the retentivity of the carrier to the magnet roller becomes low, which may cause so-called carrier scattering or other problems. Especially, recent tendencies to make the diameter of toner particles smaller in order to meet the demand for high-quality image formation require smaller carrier particles. However, the downsizing of the carrier particles could lead to reduction in the retentivity of each carrier particle. Effective measures are required to prevent carrier scattering.

Among the various disclosed techniques relating to the carrier core particles, Japanese Unexamined Patent Application Publication No. 2008-241742 (PTL 1) discloses a technique with the aim of preventing the carrier from scattering.

### CITATION LIST

### Patent Literature

PTL 1; JP-A No. 2008-241742

### SUMMARY OF INVENTION

### Technical Problem

The carrier core particles are also required to have good electrical properties, more specifically, for example, to be capable of storing a large amount of electric charges and having a high dielectric breakdown voltage. Furthermore, the carrier core particles themselves are required to have appropriate resistivity from the aforementioned viewpoints. For example, even if the coating resin of carrier partially comes off after long-term use, the carrier that is made of carrier core particles with high insulation quality can prevent charge leakage, which causes image defects, and can have a prolonged life. If the carrier core particles have appropriate resistivity, the carrier will not have high enough resistance to reduce image density that causes image defects. Specifically, the resistivity preferably ranges from 1×10⁴ to 1×10¹¹ Ω·cm.

In general, copying machines are installed and used in offices of companies; however, there are various office environments around the world. For instance, some copying machines are used under high-temperature environments at approximately 30° C., while some are used under high-humidity environments at approximately 90% RH. On the contrary, some copying machines are used under low-temperature environments at approximately 10° C., while some are used under low-humidity environments at approximately 35% RH. Under the circumstances, the developer in a developing apparatus of a copying machine is required to have properties that do not largely change with temperature and relative humidity. Carrier core particles, which make up carrier, are also required to reduce their property changes in various environments, in other words, to be less dependent on environments.

The inventors of the present invention thoroughly investigated the causes why the physical properties, such as the amount of charge and resistivity, of the carrier change depending on the usage environment, and found out that the physical property change of the carrier core particles greatly influences the physical properties of the coated carrier. It has also been found out that the conventional carrier core particles as represented by PTL 1 are inadequate to reduce environmental dependency. Actually, the resistivity of the carrier core particles in relatively high relative-humidity environments sometimes deteriorate more than that in relatively low relative-humidity environments. Such carrier core particles can be greatly affected by environmental variations and therefore may degrade image quality.

### Solution to Problem

For the purpose of achieving carrier core particles having excellent electrical properties, the inventors of the present invention firstly contemplated the use of iron as a main ingredient of the core composition to obtain good magnetic properties as a basic characteristic, and secondly diligently searched for additives that optimize the resistivity but do not impair the magnetic properties. As a result, it has been found that a trace amount of Na (sodium) effectively works to suppress the rise of resistivity. It has been also found that adding a predetermined amount of Na can ensure both high magnetization and high insulation quality.

Further diligent study led the inventors to conclude that, although the inventors tried to add various amounts of Na, slightly excessive amounts of Na added to the carrier core particles have an adverse effect on environmental dependency. More specifically speaking, although the added Na is uniformly mixed in the carrier core particle, Na on the surface of the carrier core particle absorbs moisture that exists in relatively large amounts in environments of high relative-humidity and induces charge leakage, resulting in reduction of the resistivity under the environments of high relative humidity and therefore a large difference in the properties depending on the environments was made. To mitigate the effect on environmental dependency possibly derived from Na and optimize the resistivity, the inventors have limited the range of Na content of the carrier core particle. This mechanism probably can optimize resistivity and reduce environmental dependency.

The carrier core particles for electrophotographic developer according to the invention include a core composition expressed by a general formula Fe304 as a main ingredient and 30 ppm to 400 ppm (parts per million) Na.

Limiting the range of Na content in the carrier core particles to 30 ppm or more is preferable to optimize the resistivity and therefore prevent reduction in image density, which is caused by high resistivity. Limiting the range of Na content in the carrier core particles to 400 ppm or less is preferable to prevent significant changes in the properties according to the environments, which is caused by excessive amounts of Na.

Such carrier core particles can reduce the dependence of the carrier core particles on environments, while optimizing resistivity. Note that the carrier core particles include the core composition expressed by Fe₃O₄; however, also they include a trace amount of Fe₂O₃.

The contents of Na in the carrier core particles were analyzed by the following method. The carrier core particles of the invention were dissolved in an acid solution and quantitatively analyzed with ICP. The ICP analysis was conducted with ICPS-7510 produced by SHIMADZU CORPORATION, and the employed ICP measurement was a calibration curve method. The wavelength of Na was set to 589.592 nm. The content of Na in the carrier core particles described in this invention is the quantity of Na that was quantitatively analyzed with the ICP. Sometimes the analysis results of the Na contents may vary due to entry of Na from a beaker or during processes. Therefore, the analysis should be conducted conditionally on the absence of Na entry. Specifically, for example, systems to which Na is not added at all are used to analyze how much Na has entered from the beaker or during processes. The obtained amount of Na is subtracted to determine the Na content of the carrier core particles. Alternatively, the Na content can be analyzed by other analysis methods that prevent Na entry as much as possible.

For the purpose of further reducing environmental dependency, the preferable Na content is limited to a range from 50 ppm to 200 ppm.

Another aspect of the present invention is directed to carrier for electrophotographic developer. The carrier includes carrier core particles having a core composition expressed by a general formula Fe₃O₄ as a main ingredient and 30 ppm to 400 ppm Na and resin coating the surfaces of the carrier core particles.

Such carrier for the electrophotographic developer including the carrier core particles having the aforementioned composition has excellent electrical properties and low environmental dependency.

Yet another aspect of the present invention is directed to electrophotographic developer that is used to develop electrophotography and includes carrier and toner. The carrier includes carrier core particles having a core composition expressed by a general formula Fe₃O₄ as a main ingredient and 30 ppm to 400 ppm Na and includes resin coating the surfaces of the carrier core particles. The toner can be triboelectrically charged by frictional contact with the carrier for development of electrophotography.

Such electrophotographic developer having the carrier with the aforementioned composition can form good quality images in various environments.

Yet another aspect of the present invention is directed to a method for manufacturing carrier core particles for electrophotographic developer that contain iron, oxygen and sodium as a core composition, the method including a granulation step of granulating a mixture of a raw material containing iron and a raw material containing sodium so that the mixture contains 100 ppm to 1000 ppm Na, and a firing step of firing powdery material obtained by granulating the mixture in the granulation step.

Such a manufacturing method can efficiently manufacture the carrier core particles having the aforementioned composition.

More preferably, the firing step can include a cooling step of cooling the powdery material under an atmosphere with an oxygen concentration controlled to 0.001% or higher. This cooling step can still reduce environmental dependency.

### Advantageous Effects of Invention

The carrier core particles for electrophotographic developer according to the invention have excellent electrical properties and low environmental dependency.

The carrier for the electrophotographic developer according to the invention has excellent electrical properties and low environmental dependency.

The electrophotographic developer according to the invention can form good quality images in various environments.

The manufacturing method according to the invention can efficiently manufacture the carrier core particles for electrophotographic developer having the aforementioned composition.

### BRIEF DESCRIPTION OF THE DRAWINGS

FIG. 1 is an electron micrograph showing the appearance of carrier core particles according to an embodiment of the invention.

FIG. 2 is a flow chart showing the main steps of a method for manufacturing the carrier core particles according to an embodiment of the invention.

FIG. 3 is a graph showing how the relationship between the resistivity and applied voltages varies when Na content is varied.

### DESCRIPTION OF EMBODIMENTS

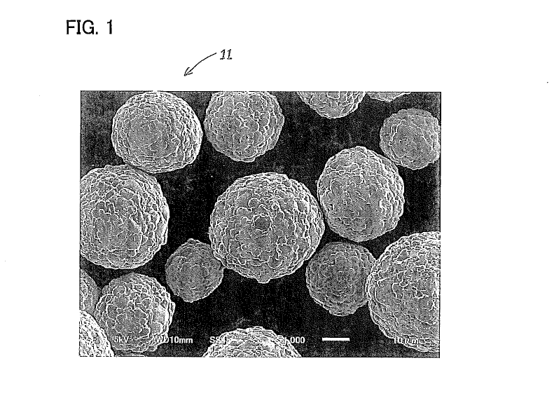

With reference to the drawings, an embodiment of the present invention will be described. First, carrier core particles according to the embodiment of the invention will be described. FIG. 1 is an electron micrograph showing the appearance of the carrier core particles according to the embodiment of the invention.

Referring to FIG. 1, carrier core particles 11 according to the embodiment of the invention are roughly spherical in shape, approximately 35 μm in diameter, and have proper particle size distribution. The diameter implies a volume mean diameter. The diameter and particle size distribution are set to any values to satisfy the required developer characteristics, yields of manufacturing steps and some other factors. On the surface of the carrier core particles 11, there are fine asperities formed in a firing step which will be described later.

Carrier particles of the embodiment of the invention are also roughly spherical in shape as with the carrier core particles 11. A carrier particle is made by coating, or covering, a carrier core particle with a thin resin film and has almost the same diameter as the carrier core particle 11. The surface of the carrier particle is almost completely covered with resin, which is different from the carrier core particle 11.

Developer according to the embodiment of the invention includes the carrier and toner. The toner particles are also roughly spherical in shape. The toner contains mainly styrene acrylic-based resin or polyester-based resin and also contains a predetermined amount of pigment, wax and other ingredients combined therewith. The toner of this type is manufactured by, for example, a pulverizing method or polymerizing method. The toner particle in use is, for example, approximately 5 μm in diameter, which is about one-seventh of the diameter of the carrier particle. The compounding ratio of the toner and carrier is also set to any value according to the required developer characteristics. The developer of this type is manufactured by mixing a predetermined amount of the carrier and toner by a suitable mixer.

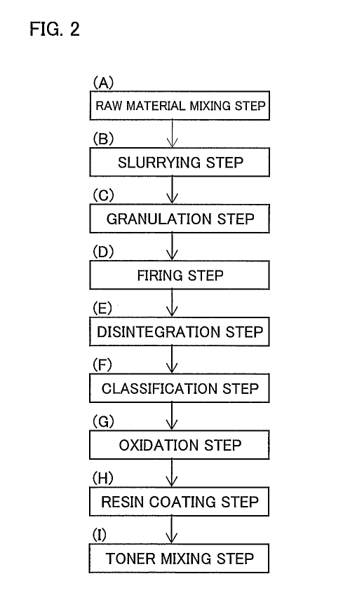

A method for manufacturing the carrier core particles according to the embodiment of the invention will be described. FIG. 2 is a flow chart showing main steps in the method for manufacturing the carrier core particles according to the embodiment of the invention. Along FIG. 2, the method for manufacturing the carrier core particles according to the embodiment of the invention will be described below.

First, a raw material containing sodium (Na) and a raw material containing iron are prepared. The prepared raw materials are formulated at an appropriate compounding ratio to meet the required properties, and mixed (FIG. 2(A)). The appropriate compounding ratio is designed so as to obtain the final carrier core particles containing 30 ppm to 400 ppm Na. Since Na evaporates during a calcinating step, firing step, or an oxidation step, the compounding ratio is determined in anticipation of the Na amounts that will evaporate during the steps. Specifically, for example, a raw material containing iron and a raw material containing sodium are mixed in the granulation step, which will be described later, into granulated powder so as to contain 100 ppm to 1000 ppm Na. Although Na is contained in iron oxide and other raw materials, the Na contained in the raw materials will mostly evaporate during the firing step or other steps. Therefore, the Na is outside the scope of incidental impurity in the present invention. In other words, the Na content of carrier core particles intentionally manufactured with systems that do not include raw materials containing Na is inevitably less than the Na content defined in the present invention.

The iron raw material making up the carrier core particles according to the embodiment of the invention can be metallic iron or an oxide thereof, and more specifically, preferred materials include Fe2O₃, Fe₃O₄, and Fe, which can stably exist at room temperature and atmospheric pressure. Preferred sodium raw materials include NaOH and NaCl, which can stably exist at room temperature and atmospheric pressure. Alternatively, the aforementioned raw materials can be used respectively or can be mixed so as to obtain a target composition. The raw material of choice can be calcined and pulverized before use. To improve the mechanical strength of the carrier core particles, a trace amount of Si, such as SiO₂, can be added to the carrier core particles. The preferred SiO₂ raw material to be added includes amorphous silica, crystalline silica, colloidal silica or the like.

Next, the mixed raw materials are slurried (FIG. 2(B)). In other words, these raw materials are weighed to make a target composition of the carrier core particles and mixed together to make a slurry raw material.

In the process for manufacturing the carrier core particles according to the invention, a reducing agent may be added to the slurry raw material at a part of a firing step, which will be described later, to accelerate reduction reaction. A preferred reducing agent may be carbon powder, polycarboxylic acid-based organic substance, polyacrylic acid-based organic substance, maleic acid, acetic acid, polyvinyl alcohol (PVA)-based organic substance, or mixtures thereof.

Water is added to the slurry raw material that is then mixed and agitated so as to contain 40 wt % or more of solids, preferably 50 wt % or more. The slurry raw material containing 50 wt % or more of solids is preferable because such a material can maintain strength when it is granulated into pellets.

Subsequently, the slurried raw material is granulated (FIG. 2(C)). Granulation of the slurry obtained by mixing and agitation is performed with a spray dryer. Note that it is further preferable to subject the slurry to wet pulverization before the granulation step.

The temperature of an atmosphere during spray drying can be set to approximately 100° C. to 300° C. This can provide granulated powder whose particles are approximately 10 to 200 μm in diameter. In consideration of the final particle diameter of a product, it is preferable to filter the granulated powder with a vibrating sieve or the like to remove coarse particles and fine powder for particle size adjustment at this point of time

The granulated material is then fired (FIG. 2(D)). Specifically, the obtained granulated powder is placed in a furnace heated to approximately 900° C. to 1500° C. in a heat-up step and is kept in the furnace for 1 to 24 hours to undergo sintering in order to produce a target fired material. Then, the fired material is cooled to approximately room temperature in a cooling step. As described above, the firing step is broadly divided into three steps. In short, the firing step includes three steps: a heat-up step of rising temperature of the powdery material granulated in the granulation step to sintering temperature; a sintering step of keeping the powdery material, after the heat-up step, at a predetermined sintering temperature for a predetermined period of time to sinter the powdery material; and a cooling step of cooling the powdery material after sintering. During the steps, the oxygen concentration in the firing furnace can be set to any value, but should be enough to advance ferritization reaction. Specifically speaking, when the furnace is heated to 1200° C., a gas is introduced and flows in the furnace to adjust the oxygen concentration to 10⁻⁷% to 3%. For oxygen concentration adjustment, an oxygen analyzer (a zirconia type O₂ sensor TB-IIF+control unit) produced by DAIICHI NEKKEN CO., LTD was used.

Alternatively, a reduction atmosphere required for ferritization can be controlled by adjusting the aforementioned reducing agent. To achieve a reaction speed that provides sufficient productivity in an industrial operation, the preferable temperature is 900° C. or higher. If the firing temperature is 1500° C. or lower, excessive sintering between the particles does not occur and the particles can remain in the form of powder upon completion of firing.

From the viewpoint of reduction in environmental dependency, it is advantageous for the carrier core particles to contain a slightly excessive amount of oxygen in the core composition. One of the possible means for adding a slightly excessive amount of oxygen in the core composition is to set the oxygen concentration during the cooling step in the firing step to a predetermined value or higher. Specifically, when the core particles are cooled to approximately room temperature in the firing step, the oxygen concentration is set to a predetermined value, more specifically, the cooling step is executed under an atmosphere at an oxygen concentration of 0.001% or higher. More specifically, a gas with an oxygen concentration of 0.001% or higher, or more preferably 0.001% to 1%, is introduced into the electric furnace and continues flowing during the cooling step. This allows the internal layer of the carrier core particle to contain ferrite with an excessive amount of oxygen. The relatively high content of oxygen in the internal layer of the carrier core particles can prevent the resistivity reduction caused by charge leakage or the like occurring in high-temperature and high-humidity environments. Therefore, the cooling operation should be performed in an environment at the aforementioned oxygen concentration.

It is preferable at this stage to adjust the size of particles of the fired material again. For instance, the fired material is coarsely ground by a hammer mill or the like. In other words, the fired granules are disintegrated (FIG. 2(E)). After disintegration, classification is carried out with a vibrating sieve or the like. In other words, the disintegrated granules are classified (FIG. 2(F)) to obtain carrier core particles with a desired diameter.

Then, the classified granules undergo oxidation (FIG. 2(G)). The surfaces of the carrier core particles obtained at this stage are heat-treated (oxidized).

More specifically, the granules are placed in an atmosphere at an oxygen concentration of 10% to 100%, at a temperature of 200° C. to 700° C., for 0.1 to 24 hours to obtain the target carrier core particles. More preferably, the granules are placed at a temperature of 250° C. to 600° C. for 0.5 to 20 hours, further more preferably, at a temperature of 300° C. to 550° C. for 1 to 12 hours. In this manner, the carrier core particles according to the embodiment of the invention are manufactured. Note that the oxidation step is optionally executed when necessary.

The method for manufacturing the carrier core particles for electrophotographic developer according to the invention is a method for manufacturing the carrier core particles containing iron, oxygen and sodium as the core composition, and the method includes a granulation step of granulating a mixture of a raw material containing iron and a raw material containing sodium so that the mixture contains 100 ppm to 1000 ppm Na and a firing step of firing powdery material obtained by granulating the mixture in the granulation step.

Such a method for manufacturing the carrier core particles for electrophotographic developer can efficiently manufacture the carrier core particles having the aforementioned composition.

The firing step in this manufacturing method includes a cooling step performed under an atmosphere with an oxygen concentration of 0.001% or higher, thereby reducing environmental dependency.

The carrier core particles thus obtained are coated with resin (FIG. 2(H)). Specifically, the carrier core particles according to the invention are coated with silicone-based resin, acrylic resin, or the like. Carrier for electrophotographic developer according to the embodiment of the invention is achieved in this manner. The coating with silicone-based resin, acrylic resin or the like can be done by well-known techniques. The carrier for the electrophotographic developer according to the invention includes the carrier core particles having a core composition expressed by a general formula Fe₃O₄ as a main ingredient and 30 ppm to 400 ppm Na, and a resin that coats the surfaces of the carrier core particles.

The carrier for the electrophotographic developer that includes the carrier core particles having the aforementioned composition have excellent electrical properties and low environmental dependency.

Next, the carrier thus obtained and toner are mixed in predetermined amounts (FIG. 2(I)). Specifically, the carrier, which is obtained through the above mentioned manufacturing method, for the electrophotographic developer according to the embodiment of the invention is mixed with an appropriate well-known toner. In this manner, the electrophotographic developer according to the embodiment of the invention can be achieved. The carrier and toner are mixed by any type of mixer, for example, a V-shape mixer. The electrophotographic developer according to the invention is used to develop electrophotography and contains the carrier and toner. The carrier includes the carrier core particles having a core composition expressed by a general formula Fe₃O₄ as a main ingredient and 30 ppm 400 ppm Na, and resin coating the surfaces of the carrier core particles. The toner can be triboelectrically charged by frictional contact with the carrier for development of electrophotography.

Such electrophotographic developer that includes the carrier having the aforementioned composition can form good quality images in various environments.

### EXAMPLES

### Example 1

15 kg of Fe2O₃ (average particle diameter: 0.6 μm), was dispersed in 3.8 kg of water, and 150 g of ammonium polycarboxylate-based dispersant, 170 g of carbon black reducing agent, 398 g of colloidal silica (solid concentration: 50%) as a SiO₂ raw material, and 3 g of NaOH were added to make a mixture. The solid concentration of the mixture was measured and resulted in 75 wt %. The mixture was pulverized by a wet ball mill (media diameter: 2 mm) to obtain mixture slurry.

The slurry was sprayed into hot air of approximately 130° C. by a spray dryer and turned into dried granulated powder. At this stage, granulated powder particles out of the target particle size distribution were removed by a sieve. This granulated powder was placed in an electric furnace and fired at 1075° C. for three hours. During firing, gas was controlled to flow in the electric furnace such that the atmosphere in the electric furnace was adjusted to have an oxygen concentration of 0.03%. The atmosphere was also controlled to have an oxygen concentration of 0.03% even during the cooling step. The obtained fired material was disintegrated and then classified by a sieve, thereby obtaining carrier core particles whose volume mean diameter is 35 μm. The resultant carrier core particles were then maintained in an atmosphere at 550° C. for one hour for oxidation to obtain carrier core particles of Example 1. Table 1 shows the physical, electrical and magnetic properties of the resultant carrier core particles. Note that the core compositions listed in Table 1 were obtained by measuring the carrier core particles through the aforementioned analysis method. The core compositions of Example 2 and subsequent examples were also obtained through the same method.

### Example 2

The carrier core particles of Example 2 were obtained in the same manner as in Example 1, but the added NaOH was 8 g. Table 1 shows the physical, electrical and magnetic properties of the resultant carrier core particles.

### Example 3

The carrier core particles of Example 3 were obtained in the same manner as in Example 1, but the added NaOH was 18 g. Table 1 shows the physical, electrical and magnetic properties of the resultant carrier core particles.

### Example 4

The carrier core particles of Example 4 were obtained in the same manner as in Example 1, but the added NaOH was 30 g. Table 1 shows the physical, electrical and magnetic properties of the resultant carrier core particles.

### Comparative Example 1

The carrier core particles of Comparative example 1 were obtained in the same manner as in Example 1, but the added NaOH was 0.5 g. Table 1 shows the physical, electrical and magnetic properties of the resultant carrier core particles.

### Comparative example 2

The carrier core particles of Comparative example 2 were obtained in the same manner as in Example 1, but the added NaOH was 35 g. Table 1 shows the physical, electrical and magnetic properties of the resultant carrier core particles.

TABLE 1

| | | | | | | | | | | | ENVIRON- |
|---|---|---|---|---|---|---|---|---|---|---|---|
| | OXI- | | | | | | | | | | MENTAL |
| | DATION | OXI- | | | | | | | | | DIFFER- |
| | TEMPER- | DATION | Na | | RESISTIVITY | | | | | | ENCE |
| | ATURE | TIME | CONTENT | σ₁₀₀₀ | 50 V | 100 V | 250 V | 500 V | 750 V | 1000 V | 100 V |
| | (° C.) | (HOURS) | (ppm) | (emu/g) | (Ω · cm) | (Ω · cm) | (Ω · cm) | (Ω · cm) | (Ω · cm) | (Ω · cm) | (LogR) |
| EXAMPLE 1 | 550 | 2 | 31 | 59.7 | 3.4E+09 | 2.8E+09 | 3.0E+09 | 5.1E+09 | 7.1E+09 | 9.0E+09 | 1.2 |
| EXAMPLE 2 | 550 | 2 | 55 | 61.9 | 9.7E+08 | 9.2E+08 | 9.2E+08 | 1.2E+09 | 1.7E+09 | 2.0E+09 | 0.8 |
| EXAMPLE 3 | 550 | 2 | 170 | 62.3 | 5.4E+08 | 3.8E+08 | 3.1E+08 | 3.9E+08 | 5.0E+08 | 3.7E+08 | 0.8 |
| EXAMPLE 4 | 550 | 2 | 400 | 56.0 | 3.2E+08 | 2.3E+08 | 2.0E+08 | 2.7E+08 | 2.9E+08 | 1.7E+08 | 1.1 |
| COMPARA- | 550 | 2 | 9 | 61.9 | 4.5E+10 | 5.5E+10 | 7.2E+10 | 8.5E+10 | 8.9E+10 | 8.5E+10 | 1.3 |
| TIVE | | | | | | | | | | | |
| EXAMPLE 1 | | | | | | | | | | | |
| COMPARA- | 550 | 2 | 900 | 53.5 | 2.1E+08 | 1.5E+08 | 1.3E+08 | 1.8E+08 | 1.5E+08 | B.D. | 2.2 |
| TIVE | | | | | | | | | | | |
| EXAMPLE 2 | | | | | | | | | | | |

The oxidation temperatures listed as an oxidation condition in Table 1 denote temperatures (° C.) in the above-described oxidation step and were set to 550° C. for every example. The oxidation time was set to 2 hours also for every example. The Na contents were measured as described above. Note that “B.D.” in Table 1 indicates that electrical breakdown occurs in the particles.

Measurement of the resistivity will be now described. The carrier core particles were placed in an environment at 10° C. and 35% RH (LL environment) and at 30° C. and 90% RH (HH environment) for a day to control moisture and then measured in the respective environments. First, two SUS (JIS) 304 plates each having a thickness of 2 mm and an electropolished surface were disposed as electrodes on a horizontally-placed insulating plate, or, for example, an acrylic plate coated with Teflon (trade mark) so that the electrodes are spaced 1 mm apart. The two electrode plates were placed so that their normal lines extend in the horizontal direction. After 200±1 mg of powder to be measured was charged in a gap between the two electrode plates, magnets having a cross-sectional area of 240 mm² were disposed behind the respective electrode plates to form a bridge made of the powder between the electrodes. While keeping the state, DC voltages were applied between the electrodes in the increasing order of the voltage values, and the value of current passing through the powder was measured by a two-terminal method to determine the value of electrical resistivity. For the measurement, a super megohmmeter, SM-8215 produced by HIOKI E. E. CORPORATION, was used. The resistivity value is expressed by a formula: resistivity (Ω·cm)=measured resistance value (Ω)×cross-sectional area (2.4 cm²)÷inter-electrode distance (0.1 cm). The resistivity (Ω·cm) of the powder applied with the voltages listed in Table 1 was measured. Note that the magnets in use can be anything as long as they can cause the powder to form a bridge. In this embodiment, a permanent magnet, for example, a ferrite magnet, having a surface magnetic flux density of 1000 gauss or higher was used.

The resistivity values in Table 1 are resistivity values under the LL environment represented logarithmically. In other words, 1×10⁶ Ω·cm=Log R=6.0. The environmental difference in resistivity shows values obtained by subtracting the resistivity values in the high-temperature and high-humidity environment from the resistivity values in the low-temperature and low-humidity environment with application of 100 V. The item “σ1000” in Table 1 indicates magnetization in an external magnetic field of 1000 Oe.

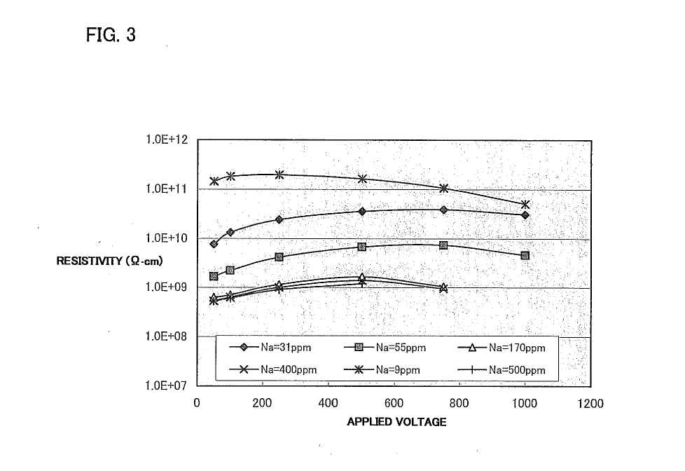

FIG. 3 is a graph showing how the relationship between the resistance value and applied voltage varies with varying Na contents, regarding Examples 1 to 4 and Comparative examples 1 and 2. In FIG. 3, the vertical axis represents the resistivity (Ω·cm), while the horizontal axis represents the applied voltages (V). In FIG. 3, the resistivity on the vertical axis is represented by 1.0E+10 that stands for 1×10¹⁰.

Referring to Table 1 and FIG. 3, the resistivity of Comparative example 1 is higher than 1.0E+11 Ω·cm with application of 750 V or lower. On the other hand, the resistivity values of Examples 1 to 4 are all lower than 1.0E+11 Ω·cm with application of any voltage levels, i.e., 1×10¹¹ Ω·cm or lower. The results show that the carrier core particles of Examples 1 to 4 have appropriate resistivity in comparison with the carrier core particles of Comparative example 1. This is probably because a relatively high proportion of Na in the internal layer of the carrier core particles whose main ingredient is crystalline Fe₃O₄ containing a trace amount of Na causes very small charge leakage, resulting in slight reduction of the resistivity.

As to the environmental difference in resistivity, Comparative examples 1 and 2 exhibit 1.3 and 1.5, respectively, while all Examples 1 to 4 exhibit 1.2 or lower. In short, Examples 1 to 4 have relatively small differences in resistivity between the environments, and therefore it can be said they have low environmental dependency.

Examples 1 to 4 all have a magnetization of 50 emu/g or higher and therefore have no problems in practical use.

As described above, since the carrier core particles for electrophotographic developer according to the invention include the aforementioned composition, they have good electrical properties and low environmental dependency.

The Examples 2 and 3 have environmental differences of 0.8, or at least 1 or less. The results show that it is preferable to limit the range of Na content in the carrier core particles to 50 ppm to 200 ppm in order to reduce environmental dependency. The carrier core particles of both Examples 2 and 3 have a magnetization (σ₁₀₀₀) of 60 emu/g or higher, and therefore can find applications requiring higher magnetization.

In the above-described embodiment, Na is added in the form of NaOH or NaCl; however, the present invention is not limited thereto, and other forms of Na, for example, NaHCO₃ can be used to add Na.

The sintering step of accelerating the sintering reaction, which is executed prior to the cooling step, can be performed under the same atmosphere as in the cooling step.

Although the firing step includes the cooling step, which cools the particles under an atmosphere with an oxygen concentration of 0.001% or higher, the cooling step can be omitted if the carrier core particles have as low environmental dependency as required. In other words, the cooling step can be performed under an atmosphere with an oxygen concentration of less than 0.001%.

The foregoing has described the embodiment of the present invention by referring to the drawings. However, the invention should not be limited to the illustrated embodiment. It should be appreciated that various modifications and changes can be made to the illustrated embodiment within the scope of the appended claims and their equivalents.

### INDUSTRIAL APPLICABILITY

The carrier core particles for electrophotographic developer, the carrier for electrophotographic developer, the electrophotographic developer and the method for manufacturing the carrier core particles according to the invention can be effectively used when applied to copying machines or the like in various usage environments.

### REFERENCE SIGNS LIST

11; carrier core particles

1. Carrier core particles for electrophotographic developer comprising:
a core composition expressed by a general formula Fe₃O₄ as a main ingredient; and
30 ppm to 400 ppm Na.

2. The carrier core particles for electrophotographic developer according to claim 1, wherein the Na content is limited to a range from 50 ppm to 200 ppm.

3. Carrier for electrophotographic developer comprising:
carrier core particles including a core composition expressed by a general formula Fe₃O₄ as a main ingredient and 30 ppm to 400 ppm Na; and
resin coating the surfaces of the carrier core particles.

4. Electrophotographic developer used to develop electrophotography, comprising:
carrier that includes carrier core particles having a core composition expressed by a general formula Fe₃O₄ as a main ingredient and 30 ppm to 400 ppm Na, and resin coating the surfaces of the carrier core particles; and
toner that can be triboelectrically charged by frictional contact with the carrier for development of electrophotography.

5. A method for manufacturing carrier core particles for electrophotographic developer, the carrier core particles containing iron, oxygen and sodium in a core composition, the method comprising:
a granulation step of granulating a mixture of a raw material containing iron and a raw material containing sodium so that the mixture contains 100 ppm to 1000 ppm Na; and
a firing step of firing powdery material obtained by granulating the mixture in the granulation step.

6. The method for manufacturing carrier core particles for electrophotographic developer according to claim 5, wherein the firing step includes a cooling step performed under an atmosphere with an oxygen concentration of 0.001% or higher.
